(19) United States
(12) Patent Application Publication
(10) Pub. No.: US 2007/0142262 A1
(43) Pub. Date: Jun. 21, 2007

(54) Bacteria capturing treatment for fibrous webs

(75) Inventors: Curtis N. Sayre, Atlanta, GA (US); Lei Huang, Duluth, GA (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/303,004

(22) Filed: Dec. 15, 2005

(51) Int. Cl. C11D 17/00

(52) U.S. Cl. 510/438; 510/439

(57) ABSTRACT

A fibrous web containing a composition capable to tract and/or trap negatively charged matter, such as bacteria and other pathogens, is generally disclosed. The bacteriostatic composition can be a multivalently charged metal ion, such as an aluminum cation, ligated to at least one surfactant. The surfactant can be an anionic surfactant, such as an alkyl sulfate. Also, methods of forming a fibrous web capable of trapping negatively charged matter is generally provided.

### BACKGROUND OF THE INVENTION

A myriad of different types of fibrous webs are commercially available in today's marketplace. These fibrous webs can contain chemicals designed with a particular use in mind. For example, fibrous webs can be used to deliver chemicals designed to kill pathogens, such as bacteria, when the web comes into contact with them.

However, as concern grows about allergic or toxological reactions to chemicals and about the increasing resistance of bacteria to common antibacterial agents and drug treatments, it has become more desirous to avoid harsh chemicals while still providing a bacteria removing web.

Many pathogens are generally electrostatically charged. For example, most bacteria are negatively charged. As such, pathogens, such as bacteria, are susceptible to electrostatic attraction to oppositely charged molecules. For instance, negatively charged bacteria can be attracted to a positively charged molecule, such as a cation. While this attraction may not kill the attracted bacteria, it can help remove the bacteria from its environment.

As such, a need currently exists for a fibrous web that can provide a decontamination effect without the undesirable exposure to harsh antimicrobial chemicals. A need also exists for a web that can have a decontamination effect through the use of electrostatic forces.

### SUMMARY OF THE INVENTION

In general, the present disclosure is directed toward a fibrous web capable of trapping negatively charged matter, and methods of making the same. In one embodiment, the present disclosure is directed to a fibrous web comprising fibers and a composition applied to the web such that the web is capable of attracting and trapping negatively charged matter. For example, the composition can comprise a complex of at least one multivalently charged metal cation and at least one electron-rich compound selected from the group consisting of a surfactant, an alcohol, and a processing aid.

In one embodiment, the composition can comprise a multivalently charged metal cation and at least one surfactant, such as a complex comprising at least one multivalently charged metal cation and at least one surfactant. For example, the multivalently charged metal cation can be an aluminum cation, such as an aluminum cation supplied from an aluminum salt. The surfactant can be an anionic surfactant or a nonionic surfactant. The anionic surfactant can be a monovalent anionic surfactant or a divalent anionic surfactant.

Other features and aspects of the present invention are discussed in greater detail below.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

In general, the present disclosure is directed toward a fibrous web containing a bacteriostatic composition. The bacteriostatic composition can attract and/or trap pathogens, such as bacteria, into the web. As such, the bacteriostatic composition allows the web to help prevent transfer of bacteria through the web. Also, the bacteriostatic composition can substantially hold the pathogens in the web to help prevent the spread of the pathogens to other surfaces that may contact the web.

According to the present disclosure, the bacteriostatic composition can attract and trap negatively charged matter, such as bacteria and other pathogens, through the application of physical means and Coulombic attraction, without the use of harsh chemicals such as some antimicrobials. For example, the bacteriostatic composition can provide a net positive charge to the web that can electrostatically attract and/or trap negatively charged matter, such as molecules, particles, microbes, cells, fungi, anions, other microorganisms, pathogens, and the like. Also, the bacteriostatic composition can hinder the reproduction and growth of bacteria that is trapped within the web.

The bacteriostatic composition can also interact, such as chemically, electrostatically, or physically, with the fibers of the web. As such, the bacteriostatic composition can become integral to the fibers of the web and can become embedded into the web.

For example, in one embodiment, the bacteriostatic composition can include a complex of at least one multivalently-charged metal ion, such as an aluminum cation and at least one surfactant, such as an anionic surfactant. The term “complex” is meant to include any type of combination, such as bonded (ionically or covalently), ligated, oligomers, and the like. In other embodiments, the bacteriostatic composition can included a complex of at least one multivalently-charged metal ion and at least one electron-rich compound, such as a surfactant, an alcohol, or other processing aids. Suitable alcohols include, but are not limited to, octanol, hexanol, isopropanol, ethanol. Processing aids are meant to include wetting agent surfactants, viscosity modifiers (e.g., polyvinyl pyrrolidone, ethyl hydroxy ethyl cellulose, and the like), binding agents, surface modifiers, salts, pH-modifiers, and the like.

It is to be understood that any charged metal cation, such as any multivalently charged metal ion, can be used in accordance with the present disclosure. The remainder of this disclosure is directed to a particular embodiment, wherein the metal cation is an aluminum cation, with the understanding that the present disclosure is not limited to an aluminum cation.

Aluminum cations generally have a valance of +3. The aluminum cation can provide a positive charge to the fibrous web that can electostatically attract and/or trap and/or retain negatively charged compositions, including bacteria. The aluminum cation can be ligated to a surfactant, such as an anionic surfactant. The anionic surfactant can have any valance, such as monovalent (−1), divalent (−2), trivalent (−3), and so on. In this embodiment, the ionically bonded molecule can have a net charge of zero. However, a positive charge can still be provided to the web by localization of the positive charge on the Al cation and by balancing the ligand/metal ion ratio.

For example, the aluminum cation can be ionically bonded to a monovalent anionic surfactant, which generally can be represented by the formula:
AlR₃₋ₙXₙ
wherein R is the monovalent anionic surfactant, X is the remaining counterions from the original aluminum salt, and n is an integer from 0-2.

In another example, the aluminum cation can be ionically bonded to a divalent anionic surfactant, which can be generally represented by the formula:
Al₂R₃₋ₙX₂ₙ
wherein R is the divalent anionic surfactant, X is the remaining counterions (valence of −1) from the original aluminum salt, and n is an integer from 0-2.

In some embodiments, the anionic surfactant can be, among others, linear and branched-chain alkylbenzenesulfonates; linear and branched-chain alkyl sulfates; linear and branched-chain alkyl ethoxy sulfates; silicone phosphate esters, silicone sulfates, and silicone carboxylates such as those manufactured by Lambent Technologies, located in Norcross, Ga. In addition, the anionic surfactant can be supplied from fatty acid salts (like sodium or potassium stearate, sodium or potassium oleate, and the like).

For example, in some particular embodiments, the anionic surfactant can contain alkyl chains in the surfactant, such as alkylsulfate anions (or alkylsulfonates). Examples of alkylsulfate anions include, but are not limited to, dodecyl sulfate (SDS, also known as lauryl sulfate, SLS), tetradecyl sulfate (STS), hexadecyl sulfate (SHS), and the like. Alkyl chains on the anionic surfactant can help the surfactant remain in the fibrous web's matrix by interacting, either physically or chemically, with the fibers of the web. For example, the surfactant can ligate the metal ion to form an insoluble precipitate on the fibers in the web.

In one embodiment, the aluminum surfactant can be provided to the web by a reaction of a soluble aluminum salt and a surfactant treatment. For example, the reaction can be a precipitation reaction the produces the aluminum surfactant as the precipitate. The reaction can be carried out in an aqueous solution, which can be used to combine the soluble aluminum salt and the soluble surfactant treatment. Once the ingredients are combined in solution, the aluminum surfactant can precipitate out of the solution. For instance, in one embodiment, the reaction can be carried out while the web is saturated with the aqueous solution, allowing the precipitate to become integral and/or imbedded in the web's fibers.

In one embodiment, the soluble aluminum salt can be any aluminum salt that provides an aluminum cation when in a solution, such as an aqueous solution. As such, any soluble aluminum salt (or multi-valent metal) can be used. For example, the soluble aluminum salt can be aluminum chlorohydrate, aluminum chlorohydrol, sodium aluminum, potassium aluminum, aluminum sulfate, and the like.

The aluminum cation can form a complex with any electron-rich compound. For example, the electron-rich compound can be a surfactant treatment, an alcohol (either long or short chain), or a processing aid.

The surfactant treatment can be, in one embodiment, any surfactant treatment that provides an anionic surfactant (or a nonionic surfactant) when in a solution, such as an aqueous solution. For example, the surfactant treatment can be a cation ionically bonded to an anionic surfactant. The cation can be, for instance, an alkali cation, such as sodium, or an alkaline earth metal cation. In some particular embodiments, the surfactant treatment can be a sodium alkylbenzenesulfonate or a sodium alkyl sulfate, such as sodium dodecyl sulfate, sodium tetradecyl sulfate, sodium hexadecyl sulfate, and the like.

In one embodiment, the alcohol can be hexanol or octanol. The alcohol can help enhance the wetting and/or uniformly treat the fibrous webs, especially polyolefin substrates. Alcohol can be incorporated into treating formulation in a range from about 0.1 wt % to about 2 wt %, with respect to the total amount of ingredients in the composition.

In certain embodiments, the processing aids can be mixed in an aqueous solution. The formulation can be diluted to any desired or required concentration level, depending on the treatment process to achieve the desired or predetermined add on amount on a substrate for trapping negatively matter. For example, the processing aids can be present in about 0.75 wt % to about 1.0 wt %.

The bacteriostatic compositions of the present disclosure can be used in any fibrous web, such as woven and nonwoven webs. As used herein, the term “fiber” or “fibrous” refers to elongated individual natural or synthetic strands (as compared to a continuous film layer). Synthetic fibers are formed by passing a polymer through a forming orifice such as a die. Unless noted otherwise, the terms “fibers” or “fibrous” include discontinuous strands having a definite length and continuous strands of material, such as filaments. The fibrous material may comprise any one or combination of non-woven or woven. Non-woven materials may be preferred from a manufacturing standpoint. However, woven materials, including any manner of synthetic or natural cloth, are within the scope and spirit of the invention.

As used herein the term “nonwoven” material means a web having a structure of individual fibers or threads which are interlaid, but not in an identifiable manner as in a knitted fabric. Nonwoven fabrics or webs have been formed from many processes such as for example, meltblowing processes, spunbonding processes, bonded carded web processes, etc. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

The nonwoven material may comprise a non-woven meltblown web. Meltblown fibers are formed by extruding a molten thermoplastic material through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin, et al. Generally speaking, meltblown fibers may be microfibers that may be continuous or discontinuous, are generally smaller than 10 microns in diameter, and are generally tacky when deposited onto a collecting surface.

The nonwoven material may comprise a non-woven spunbond web. Spunbonded fibers are small diameter substantially continuous fibers that are formed by extruding a molten thermoplastic material from a plurality, of fine, usually circular, capillaries of a spinnerette with the diameter of the extruded fibers then being rapidly reduced as by, for example, eductive drawing and/or other well-known spunbonding mechanisms. The production of spun-bonded nonwoven webs is described and illustrated, for example, in U.S. Pat. No. 4,340,563 to Appel. et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al. Spunbond fibers are generally not tacky when they are deposited onto a collecting surface. Spunbond fibers can sometimes have diameters less than about 40 microns, and are often between about 5 to about 20 microns.

The web can be a combination of webs, such as a laminate. For example, the nonwoven material may comprise a spunbond/meltblown/spunbond laminate, or SMS material. A typical SMS material is described in U.S. Pat. No. 4,041,203 to Brock et al. Other SMS products and processes are described for example in U.S. Pat. No. 5,464,688 to Timmons et al.; U.S. Pat. No. 5,169,706 to Collier et al.; and U.S. Pat. No. 4,766,029 to Brock et al. Generally, an SMS material will consist of a meltblown web sandwiched between two exterior spunbond webs. Such SMS laminates have been available commercially for years from Kimberly-Clark Corporation under marks such as Spunguard® and Evolution®. The spunbonded layers on the SMS laminates provide durability and the internal meltblown layer provides porosity and additional cloth-like feel.

Suitable non-woven web materials may also be made from bonded carded webs and airlaid webs. Bonded carded webs are made from staple fibers which are sent through a combing or carding unit, which separates or breaks apart and aligns the staple fibers to form a nonwoven web. Once the web is formed, it then is bonded by one or more of several known bonding methods.

Airlaying is another well known process by which fibrous webs can be formed. In the airlaying process, bundles of small fibers having typical lengths ranging from about 6 to about 19 millimeters are separated and entrained in an air supply and then deposited onto a forming screen, usually with the assistance of a vacuum supply. The randomly deposited fibers then can be bonded to one another using known bonding techniques.

In one particular embodiment, the fibrous web of the present disclosure can contain olefinic fibers. Olefinic fibers are made from olefin polymers, such as polyethylene, polypropylene, and the like.

Generally, webs comprising olefinic fibers do not interact with pathogens in any way, due in part to the non-polar nature of olefinic fibers. By imbedding the bacteriostatic salt of the present disclosure into the olefinic fibrous web, the charge on the bacteriostatic salt can capture the pathogen, such as bacteria. Thus, an olefinic fibrous web, that normally would not interact with pathogens, can be modified to not only interact but also help trap pathogens. The resulting olefinic fibrous web can act as a barrier web that substantially prevents transmittance of pathogens through the web.

The present disclosure is also directed to methods of making a web capable of trapping bacteria. In one embodiment, a bacteriostatic composition can be formed by reacting an aluminum cation and an anionic surfactant. For example, in one embodiment, the web can be saturated with a first aqueous solution containing a surfactant treatment, such as the surfactant treatment discussed above. Then, a second aqueous solution containing a metal cation, such as an aluminum cation, can be added to the wet web. Alternatively, a solution containing the metal cation can be added first, and then a solution containing the surfactant solution can be added.

In one particular embodiment, the web is first saturated with a solution containing a surfactant treatment. Without wishing to be bound by theory, it is believed that the addition of the surfactant treatment solution, prior to the metal cation solution, ensures that proper mixing can occur, since most of the treated webs are hydrophobic. The surfactant treatment solution allows the web to be wetted out, thus allowing the second solution, containing the metal cation, to get in and coat the fibers.

The aluminum cation can be, for example, supplied in an aqueous solution having an aluminum salt concentration of about 0.1% to about 50%, such as from about 5% to about 25%. In one particular embodiment, the aluminum salt concentration can be from about 5% to about 15%, such as about 10%. For example, an aqueous solution of aluminum chlorohydrate and/or aluminum chlorohydrol having any of the above concentrations can be used to supply the aluminum cation to the web.

The anionic surfactant can be provided to the web, for instance, in an aqueous solution having a surfactant treatment concentration of about 0.1% to about 50%, such as from about 5% to about 25%. In one particular embodiment, the surfactant treatment concentration can be from about 5% to about 15%, such as about 10%. For example, an aqueous solution of a sodium alkylsulfate, such as sodium dodecylsulfate, sodium tetradecyl sulfate, and/or sodium hexadecyl sulfate, having any of the above concentrations can be used to supply the anionic surfactant to the web.

No matter the order of addition, once both solutions have been added to the web, the aluminum surfactant adduct or compound precipitates from the solution. Since the web is saturated with the solution, the precipitate can become deposited onto the fibers of the web. Also, the precipitate can be worked into the web through the use of physical means.

After the precipitate has formed, the web can be rinsed, to remove any loose precipitate and other soluble ions from the web, and dried. For example, the web can be rinsed with water and air-dried.

The resulting web can contain an effective amount of the aluminum surfactant to help attract and/or trap negatively charged matter, such as bacteria, into the web. For example, the aluminum surfactant can be present in the dried web in an amount that increases the web's basis weight by at least about 50%, such as from about 60% to about 120%, such as from about 75% to about 100%. In one particular embodiment, for example, the web's basis weight can be increased by about 80% to about 90%.

The bacteriostatic composition of the present disclosure, such as an aluminum surfactant, can be added to and/or included within the webs without substantially changing the properties of the web. For example, nonwoven olefinic webs can retain their barrier properties with the aluminum surfactant present within the web. Also, although the aluminum surfactant can be hydrophobic, the wettability of the web containing the aluminum surfactant is not drastically changed.

Webs treated with the bacteriostatic composition of the present disclosure can be used in any manner that the web can be used for. In particular, the treated webs can be used where decontamination is desired, such as in surgical gowns, face masks, personal care absorbent articles (such as diapers, adult incontinence products, training pants, feminine care products, and the like), wiping products (such as paper towels, napkins, facial tissue, bath tissue, industrial wipers, and the like), protective clothing, and the like.

### EXAMPLES

### Example 1

### Determining the Anionic Attraction Ability of Treated Webs

Samples of spunbond/meltblown/spunbond (SMS) material were prepared by cutting a surgical gown sold under the trade name Control* cover gown (having a basis weight of 1.0 osy) by Kimberly Clark Corp. of Neenah, Wis. The SMS laminate has a polypropylene meltblown web sandwiched between two exterior polypropylene spunbond webs.

The SMS substrate was wet with an aqueous solution containing 20% by weight sodium dodecyl sulfate (SDS). The surfactant solution immediately wet the SMS substrate. The sodium dodecyl sulfate solution was allowed to saturate the SMS substrate.

Then, an aqueous solution containing 50% by weight aluminum chlorohydrate was added to the already saturated and still wet SMS substrate. A precipitate immediately formed where the aluminum chlorohydrate solution was applied to the surfactant-soaked SMS substrate. The combined solutions and resulting precipitate were agitated and mixed by hand using a polypropylene bar until the two solutions were thoroughly mixed into the fibrous web. The non-bound precipitate was rinsed off of the nonwoven SMS With copious amounts of water, and the SMS substrate was allowed to air dry.

The ability of the treated SMS web to capture anionic material was tested by using FD&C blue #1 dye in water. The dye is an anionic dye sold by BF Goodrich under the trade name FD&C blue #1 and having the following structure:

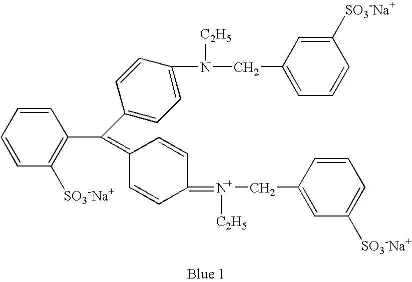

As a test, 5 μL drops of an aqueous solution containing 0.1 wt % FD&C blue #1 dye were applied to the surface of the treated SMS material and to the surface of a non-treated SMS material, for comparison. The drops beaded up on the surface of both the treated and non-treated webs. The dye solution was then rinsed off both SMS materials with water.

Once rinsed, the area where the droplets were in contact with the treated SMS web left a blue spot that could not be rinsed off with water. The control (non-treated) SMS web retained no dye.

The treated and control samples were then wet-out by using an aqueous solution containing 0.5 wt % Tween 20 (a non-ionic surfactant reported to be polyethylene glycol sorbitan monolaurate), which is sold by Fluka, a division of Sigma-Aldrich Co. The non-ionic surfactant solution almost immediately wet-out both the treated and the control SMS substrates.

Then, the dye solution was added to the wet-out SMS substrates (as described above). The dye solution droplets were immediately drawn into the substrates. When rinsed, the dye did not spread or rinse off of the treated SMS substrate, but instead was retained in and on the web. However, the non-treated, control SMS substrate failed to retain any of the dye.

### Example 2

### Optimizing the Concentrations of the Treatment Solutions

To determine what levels of loading were necessary to capture the entire 5 μL of the dye solution that is added to the SMS material, the following was performed.

Determination of the Optimal Concentration of the Aluminum Salt Solution:

Several SMS substrates, as described in Example 1, were wet with an aqueous solution containing 20 wt % sodium dodecyl sulfate. Then, the an aqueous solution containing aluminum chlorohydrate was added to each SMS substrate, allowed to precipitate out the aluminum surfactant, worked into the SMS substrate, rinsed well with water, and allowed to dry. The concentrations of the aqueous solutions containing the aluminum chlorohydrate were as follows:

50 wt %

25 wt %

10 wt %.

5 wt %

1 wt %.

Once dried each of the treated substrates were tested using the dye solution of Example 1. The substrates treated with the 50 wt % and the 25 wt % aluminum chlorohydrate solutions both blocked the pores of the material, not allowing any dye to reach the inner portion of the web. The substrate treated with the 10 wt % aluminum chlorohydrate solution captured and held all 5 μL of the dye applied. The SMS material treated with the 5 wt % aluminum chlorohydrate solution captured and held some of the dye applied, while the SMS material treated with the 1 wt % aluminum chlorohydrate solution captured and held very little of the dye.

Determination of the Optimal Concentration of the Aluminum Salt Solution:

Several SMS substrates, as described in Example 1, were wet with an aqueous solution containing 10 wt % aluminum chlorohydrate. Then, the an aqueous solution containing sodium dodecyl sulfate was added to each SMS substrate, allowed to precipitate out the aluminum surfactant, worked into the SMS substrate, rinsed well with water, and allowed to dry. The concentrations of the aqueous solutions containing the sodium dodecyl sulfate were as follows:

20 wt %

10 wt %

5 wt %

2 wt %

1 wt %.

Once dried each of the treated substrates were tested using the dye solution of Example 1. The substrates treated with the 20 wt % sodium dodecyl sulfate solution blocked the pores of the material, not allowing any dye to reach the inner portion of the web. The substrate treated with the 10 wt % sodium dodecyl sulfate solution captured and held all 5 μL of the dye applied. The SMS material treated with the 5 wt % sodium dodecyl sulfate solution captured and held some of the dye applied, while the SMS material treated with the 2 wt % and the 1 wt % sodium dodecyl sulfate solution captured and held very little of the dye.

As a result from these optimization experiments, the present inventors believe that 10% concentrations, by weight, of each the aluminum cation solution and surfactant treatment solution is the preferred concentrations.

### Example 3

### Treating SMS Laminate with Aluminium Chlorohydrate

For coating the substrates a 500 ml aqueous formulation is prepared containing 1.0 wt % alumina oligomer +99.0 wt % water/Hexanol.

A 1 wt % aluminium chlorohydrate solution was prepared by diluting a stock aluminium chlorohydrate (supplied from GEO Specialty Chemicals located in Little Rock, Ark.) solution (50 wt % solution in water, 10 mL) with de-ionized water (485 mL) and hexanol (5 ml) mixture.

An SMS untreated substrate with size of 8″×12″ was cut from a surgical gown sold under the trade name Control* cover gown (having a basis weight of 1.0 osy) by Kimberly Clark Corp. of Neenah, Wis. The SMS laminate has a meltblown web sandwiched between two exterior spunbond webs.

Treatment of the SMS substrate entailed a “dip and squeeze” protocol. Each substrate was weighed first (W_{before}) and submerged in the 1 wt % alumina oligomer solution and agitated for approximately 1 min to ensure saturation. The treated substrate was then squeezed to remove excess treatment solution using an Atlas Laboratory Wringer Type LW-1 (Atlas Electrical Devices Co., Chicago, Ill.) equipped with a 5 lb weight for the squeeze pressure. The treated substrate was heated at 85° C. for 2 hours, allowed to cool to room temperature, and washed twice with de-ionized water. Excess water was removed using the same “dip and squeeze” protocol above. The treated substrate was allowed to air dry at room temperature and then weighed again (W_{after}). The weight add-on % was calculated based on the following equation:
Add-on%=(W_{after}−W_{before})/W_{before}%

Untreated SMS control was made using the same procedure except using with de-ionized water (485 mL) and hexanol (5 ml) mixture only without alumina oligomer solution.

### Example 4

### Treating SB with Aluminium Chlorohydrate

An untreated polypropylene spunbonded nonwoven web (SB) with size of 8″×12″ (having a basis weight of 0.9 osy) was made by Kimberly Clark Corp. of Neenah, Wis. for making face masks.

Treated and untreated SB substrates were made using the same procedure as described in previous Example 3.

### Example 5

### Treating Film/SB Laminate with Aluminium Chlorohydrate

A thermally laminated substrate of a polyethylene film and a polypropylene spunbonded nonwoven web with size of 8″×12″ (0.6 mil thickness of PE film with 0.8 osy SB) was made by Kimberly Clark Corp. of Neenah, Wis. for surgical gown.

Treated and untreated Film/SB thermal laminated substrate substrates were made using the same procedure as described in previous Example 3.

### Example 6

### Streaming Zeta Potential Analysis—Used to Measure the Surface Charge of Treated and Untreated Substrates

When an electrolyte solution is forced through a porous plug of material, a streaming potential develops due to the motion of ions in the diffusion layer which can be measured by an Electro Kinetic Analyzer (from Brookhaven Instruments Corporation, Holtsville, N.Y., USA). This value is then used to calculate the zeta potential according to the formula published by D. Fairhurst and V. Ribitsch (Particle Size Distribution II, Assessment and Characterization, Chapter 22, ACS Symposium Series 472, Edited by Provider, Theodore, ISBN 0841221170).

During the sample preparation, treated and untreated wipe substrates were cut to two identical pieces (120 mm×50 mm) and then placed into the sample cell with Teflon® spacers between them. After the sample cell was mounted onto the instrument, all the air bubbles were removed by purging. Then KCl solution (1 mM, pH=5.9, Temp=22° C.) was forced through the two layers of the media and Ag/AgCl electrodes were used to measure the streaming potential. All samples were tested under similar pH, solution conductivity and using the same number of spacers.

Each testing was repeated 4 times, and the results are summarized in Table 1.

TABLE 1

| | Add-on | Streaming Zeta | Std-Dev |
|---|---|---|---|
| Material | wt % | Potential (mV) | (mV) |
| Untreated SMS Control | N/A | −9.5 | 0.1 |
| Treated SMS | 1.2 | +8.4 | 0.5 |
| Untreated SB Control | N/A | +0.9 | 0.5 |
| Treated SB | 1.0 | +12.3 | 0.6 |
| Untreated Film/SB Control | N/A | +2.4 | 0.3 |
| Treated Film/SB | 1.0 | +11.1 | 0.4 |

As can be seen from the data, the zeta potential for untreated substrates was either negative (like −9.5 mV for untreated SMS control) or low (like 0.9 mV for untreated SB control and 2.4 mV for untreated Film/SB control) at pH ˜5.9. The negative or low streaming zeta potential values for the untreated substrates indicate there should be repulsion or low capturing capacity between most bacteria and the untreated substrates. After treatment, the zeta potential for treated SMS became positive (+8.4 mV) from negative, and treated SB and Film/SB substrates became much more positive: +12.3 mV for treated SB and 11.1 mV for treated Film/SB.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A fibrous web comprising:
fibers, and
a composition applied to the web such that the web is capable of attracting and trapping negatively charged matter, said composition comprising a complex of at least one multivalently charged metal cation and at least one electron-rich compound selected from the group consisting of a surfactant, an alcohol, and a processing aid.

2. A fibrous web as in claim 1, wherein said charged metal cation is an aluminum cation.

3. A fibrous web as in claim 1, wherein said electron-rich compound is an anionic surfactant selected from the group consisting of monovalent anionic surfactants and divalent anionic surfactants.

4. A fibrous web as in claim 1, wherein said electron-rich compound is a surfactant selected from the group consisting of linear and branched-chain alkylbenzenesulfonates; linear and branched-chain alkyl sulfates; linear and branched-chain alkyl ethoxy sulfates; silicone phosphate esters, silicone sulfates, silicone carboxylates, fatty acid salts, and nonionic surfactants.

5. A fibrous web as in claim 1, wherein said electron-rich compound is an anionic surfactant selected from the group consisting of dodecyl sulfate, tetradecyl sulfate, and hexadecyl sulfate.

6. A fibrous web as in claim 1, wherein said electron-rich compound is an alcohol selected from the group consisting of octanol, hexanol, isopropanol, ethanol.

7. A fibrous web as in claim 1, wherein said electron-rich compound is a processing aid selected from the group consisting of a wetting agent surfactant, a viscosity modifier, a binding agent, a surface modifier, a salt, or a pH-modifier.

8. A fibrous web as in claim 1, wherein said complex is a precipitate that is insoluble in an aqueous solution.

9. A fibrous web as in claim 1, wherein said complex has a net positive charge.

10. A fibrous web comprising:
olefinic fibers, and
a bacteriostatic composition applied to the web such that the web is capable of attracting and trapping bacteria into the web, said bacteriostatic composition comprising a complex of at least one multivalently charged metal cation ligated to at least one surfactant.

11. A fibrous web as in claim 10, wherein said complex is selected from the group consisting of:
(a) AlR₃₋ₙXₙ and
(b) Al₂R₃₋ₙX₂ₙ,
wherein R is an anionic surfactant, X is a non-surfactant counterion having a valence of −1, and n is an integer from 0-2.

12. A fibrous web as in claim 10, wherein said complex comprises aluminum dodecylsulfate, aluminum tetradecyl sulfate, or aluminum hexadecyl sulfate.

13. A fibrous web as in claim 10, wherein said complex is formed from a reaction of an aluminum salt and a surfactant treatment.

14. A fibrous web as in claim 13, wherein said aluminum salt is selected from the group consisting of aluminum chlorohydrate, aluminum chlorohydrol, potassium aluminum, sodium aluminum, and aluminum sulfate.

15. A fibrous web as in claim 13, where said surfactant treatment is selected from the group consisting of sodium dodecylsulfate, sodium tetradecyl sulfate, and sodium hexadecyl sulfate.

16. A fibrous web as in claim 10, wherein the web is a nonwoven web selected from the group consisting of spunbond webs, meltblown webs, air laid webs, wet laid webs, and combinations and laminates thereof.

17. A method of making a web capable of trapping bacteria comprising:
providing a fibrous web comprising olefinic fibers the web having an initial basis weight;
wetting the web with a first aqueous solution, wherein the first aqueous solution contains a nonionic surfactant or an anionic surfactant;
wetting the web with a second aqueous solution, wherein the second aqueous solution contains a multivalent metal cation; and
precipitating a metal-surfactant complex from the solution such that at the metal-surfactant complex remains on or integral to the web in an amount sufficient to increase the initial basis weight of the web by at least about 5%.

18. A method as in claim 17, further comprising
rinsing any loose metal-surfactant complex from the web; and
drying the web.

19. A method as in claim 17, wherein the multivalent metal cation comprises an aluminum cation.

20. A method as in claim 17, wherein the second aqueous solution comprises aluminum hydrochlorate, aluminum chlorohydrol, aluminum sulfate, potassium aluminum, or sodium aluminum.

21. A method as in claim 17, wherein the first aqueous solution contains an anionic surfactant.

22. A method as in claim 17, wherein the first aqueous solution comprises a sodium alkyl sulfate.

23. A method as in claim 17, wherein the first aqueous solution comprises sodium dodecylsulfate, sodium tetradecyl sulfate, or sodium hexadecyl sulfate.

24. A method as in claim 17, wherein the second aqueous solution is added to the web while the web is saturated With the first aqueous solution.

25. A method as in claim 17, wherein the first aqueous solution is added to the web while the web is saturated with the second aqueous solution.

26. A method of providing a net positive charge to a web comprising:
providing a fibrous web comprising olefinic fibers the web having an initial basis weight;
wetting the web with an aqueous solution, wherein the aqueous solution contains at least one multivalently charged metal cation and at least one component selected from the group consisting of alcohols, surfactants, viscosity modifiers, binding agents, surface modifiers, salts, and pH-modifiers;
removing excess liquid from the web; and
drying the web such that the multivalent metal cation remains on or integral to the web in an amount sufficient to increase the initial basis weight of the web by at least about 1.0%.
